(19) United States
(12) Patent Application Publication
(10) Pub. No.: US 2020/0240166 A1
(43) Pub. Date: Jul. 30, 2020

(54) MECHANISM OF "ELECTRIC FUEL" AND ELECTRIC POWER STATIONS FACILITY

(71) Applicant: Peter Graner, Kfar Saba (IL)

(72) Inventor: Peter Graner, Kfar Saba (IL)

(21) Appl. No.: 16/611,533

(22) PCT Filed: May 13, 2018
(86) PCT No.: PCT/IL2018/050518

§ 371 Date: Nov. 7, 2019

(30) Foreign Application Priority Data
May 11, 2017 (IL) 252165

(51) Int. Cl. E04H 6/22; B60L 53/00; E04H 6/10; E04H 6/28; B60S 3/04; H02J 7/00; H02J 3/38

(52) U.S. Cl. CPC E04H 6/22; B60L 53/00; E04H 6/10; H02J 2300/24; B60S 3/04; H02J 7/0045; H02J 3/381; E04H 6/282

(57) ABSTRACT

The present invention relates to the field of “electric fuel” and Electric Power Station Facility, comprising a mechanism of smart upright horizontal robotic rotative two-floors elliptic carousel parking electric facilities for improving urban environment, carrying; mechanism of multiple variety smart cabins installations, integrated in various positions with various tilting angles in various possibilities, referred to as electric upright horizontal robotic two-floors elliptic carousel parking facilities, used for alternative “electric fuel” and electric power station, replacing fossil electric power station with local electric energy supply station and fossil gas station with local EV charge/discharge/accumulate/exchange/storage electric energy supply station for domestic and residential, premises, commercial public properties, public fields/area etc.

The object of the invention is to gradually change the use of storage (goods) and nationwide distribution and supply of electric energy such as; 1. Central/regional (concentrated) electric power station and distribution ultra-high electricity to nationwide grid. 2. nationwide/domestic fuel stations resources at centralized location.

To prevent disruption of normal activity and avoid exposing energy supply to various hazards (e.g. security disasters, wars, cyber-attack etc.)

### FIELD OF THE INVENTION

The present invention relates to the field of “electric fuel” and Electric Power Station Facility, comprising a mechanism of smart upright horizontal robotic rotative two-floors elliptic carousel parking electric facilities for improving urban environment, carrying; mechanism of multiple variety smart cabins installations, integrated in various positions with various tilting angles in various possibilities, referred to as electric upright horizontal robotic two-floors elliptic carousel parking facilities, used for alternative “electric fuel” and electric power station, replacing fossil electric power station with local electric energy supply station and fossil gas station with local EV charge/discharge/accumulate/exchange/storage electric energy supply station for domestic and residential, premises, commercial public properties, public fields/area etc.

The object of the invention is to gradually change the use of storage (goods) and nationwide distribution and supply of electric energy such as; 1. Central/regional (concentrated) electric power station and distribution ultra-high electricity to nationwide grid. 2. nationwide/domestic fuel stations resources at centralized location.

To prevent disruption of normal activity and avoid exposing energy supply to various hazards (e.g. security disasters, wars, cyber-attack etc.)

### BACKGROUND OF THE INVENTION

Transition and use of vehicles batteries as domestic electric energy accumulator for continuous charging and discharging (collection, distribution and storage) and transportation of electricity, are an advanced step for using locally electric power station to generate electricity as an alternative to oil pumping, gas and fuel storage, transport on ships (pips) and again storage, fossil fuel electric power station and finally converted to high voltage via transformers.

Parking facilities based, such as for example those disclosed in CN205677318U, CN205677319U, CN205502656U, JP5156583, and JP2012046997, have major drawbacks as they lack the ability to continuously charge/discharge multiple EVs without cession, and thereby they are unable to be used as an actual power source core for the implementation of an charge/discharge/accumulate/exchange/storage electric energy supply local electrical power station.

The invention creates new production (generate), robotic parking facilities integrated above solar PV panels and accumulators, in conjunction with surrounding area vicinity of local PV and solar panels in buildings and other renewable energy sources, moreover, supply of electricity to variety of consumers, as a substitute for conventional fueling stations for today's fueling, by pumping oil, gas and storage, transport with ship tankers and storage at gas stations, refining fossil and again storing in a fuel tank of vehicles. The use of robotic parking facilities, will recharge, discharge and exchange electric energy through EV batteries to domestic accumulator continuously and store for various uses such as; 1. For driving EV. 2. Supply of electricity to buildings and various consumers.

Today, fossils fuel stations are located outside cities, outskirts of cities or in areas that endanger the population and cause environmental pollution. Cities municipalities restricted adding vehicles to urban areas, and on the other hand “Urban renewal construction” increasing the demand for additional vehicles, therefore reality enforced for alternative solution for changing; streets pattern, nationwide fuel stations, nationwide electric power stations and nationwide electric grid currently in use.

Moreover, growth uses of EV, EM (electric motorcycles), EB (electric motor bicycles), cooperatives/time share vehicles, “autonomous EV” and efficient use of renewable energy sources; its inescapable changing the usage patterns on streets, creating alternate routes for bicycles and EB, while moving parked vehicles to smart upright horizontal robotic rotative two-floors elliptic carousel parking electric facility on other side of the road, using electric supply integrated above photovoltaic (PV) solar panels combined with, surrounding area vicinity of various photovoltaic (PV) solar panels above e.g. streets, junctions and electric grid poles and using any other renewable energy sources nearby. As is known, 30%-40% of the vehicles park in cities without daily use and 90% from the day vehicles parking without use, exchanging to EV will obtain huge electrical energy reservoir/accumulator, therefore, simultaneously transfer to charging/discharging EV, EM, EB, for generating electricity and supply electricity by using mechanism of “electric fuel” Electric Power Station Facility comprising; Mechanism of Horizontal Robotic Rotative Upright Two floors Elliptic Carousel Parking Electric charge/discharge/accumulate/exchange hereinafter: “electric fuel” and Electric Power Station Facility.

Accordingly, it is an object of the present invention to provide a system which is capable of utilizing upright two floors horizontal parking space in dense urban area while using all kind of vehicles' energy sources for operating the new mechanism.

It is another object of the invention to provide a combination of upright horizontal robotic two floors parking facilities to be used in street entrances (especially between buildings), to be able to transfer vehicles to other adjacent robotic parking facilities, which are located on the rear side of the buildings/streets, by using retrieval and rotative mechanism units, while simultaneously transporting and rotating or in stop position EV between various parking facilities installed respectively next to each other.

Additional way to increase accumulated electric efficiency, by utilizing several combination of smart horizontal robotic parking facilities, with surrounded nearby EV parking sites in public areas, operated by local smart control communication and exchanging electric energy with each other to be used as backup and/or electricity expansion supply from number of various renewable energy sources.

It is therefore another object of the present invention, to disclose a novel mechanism of “electric fuel” station and electric power station facility using plurality of smart upright horizontal robotic rotative two-floors elliptic carousel parking electric facilities and tower based parking facilities, such as, for example, those disclosed in patent application IL 251245, capable of continuously, without cession, provide high DC from renewable energy, charge or discharge electrical power to/from EV batteries and other local DC or AC electricity consumers in an urban or other domestic environment, such as single building, or plurality of buildings, and domestic appliances.

Other objects and advantages of this invention will become apparent as the description proceeds.

### SUMMARY OF THE INVENTION

The present invention relates to assigned for mechanism of “electric fuel” and Electric Power Station combination of; robotic parking facility integrated with receiving electricity from plurality of energy sources, such as various photovoltaic (PV) solar integrated hot water pipes panels or other renewable energy and recharged batteries of electric vehicles (EVs, EBs) from various sources, wherein said, energy sources are combined together and concentrated into high direct current (DC) or AC voltage through one or more mechanism of “electric fuel” and Electric Power Station facilities, wherein each mechanism of “electric fuel” and Electric Power Station Facility is adapted to supply plurality of high, medium, low DC voltage in continues manner and without cession even during the rotation operation of each parking facility or at night, thereby enabling to use each of said parking facility for charging/discharging plurality of DC or AC consumers/accumulators simultaneously, previous charged consumers/accumulators with DC energy, may be used as an energy source for charging other DC or AC consumers/accumulators.

According to one of embodiment of the invention, the mechanism of “electric fuel” and Electric Power Station Facility includes:

a) plurality of parking smart cabins, each of which is used for accommodating one or more EVs and includes one or more charging/discharging ports for continuously without cession charging/discharging EVs, wherein said smart cabins are mounted on an upright horizontal rotative two floors elliptic carousel conveyors connected to supporting metal frame structure of said parking facility, that uses, two sides horizontal parallel two floors elliptic arms conveyors to shift all parking cabins from one position along the parking facility to another position; and
b) an electric busbars in form of an upright two floors elliptic track rail that is mounted in parallel (on different layer) to one side conveyor, wherein said, busbars includes elliptic track rail with plurality of electric conductors and is adapted to continuously concentrate and distribute DC or AC electric power, to the one or more charging ports in each smart cabin via smart slidable multi-axial multiple electric connectors.

According to another embodiment of the invention, the slidable multiple-axial multiple electric connectors consist of electric rotary slips rings and plurality of conductors (e.g. graphite or carbon brush) that together are electrically connected to the rotating elements of the electric rotary slips rings, enable to establish bidirectional electrical connections between the charging/discharging ports and the elliptic track rail busbars conductors.

According to another embodiment of the invention, the one or more smart cabins installations, are selected from the group consisting of: variety of different tilted angles between smart cabins advances on upright two floors horizontal elliptical conveyor and relative tilted angle to the structure frame, e.g. 0° to 90° degrees parallel or serial (e.g. 30° 45° 60° degrees), depending on demand of streets configuration and dense between buildings.

According to another embodiment of the invention, in the mechanism of “electric fuel” and Electric Power Station Facility” the energy sources are obtained from batteries of parked EV and/or DC accumulator devices, in order to increase the DC or AC power supply capabilities of said mechanism of “electric fuel” and Electric Power Station Facility.

According to another embodiment of the invention, the smart cabin further comprises one or more storage spaces, thereby enabling usage of said cabin as box storage and/or storeroom or as delivery mail boxes.

According to another embodiment of the invention, the mechanism of “electric fuel” and Electric Power Station Facility further, comprises plurality of mechanism of “electric fuel” and Electric Power Station facilities, located in spare spaces above existing roadside parking space area (FIG. 5A) and provides alternative parking spaces, the number of which is equal or larger than the spared roadside parking spaces by providing novel mechanism, allow small maneuver for direct entrances and exits in all 2-sides, relatively between 0°-90° degrees to each smart cabin for vehicles to parking facilities that are capable of continuously charging/discharging EV, wherein the robotic parking facilities may include mechanism of rotary & robotic layers-based horizontal parking facilities, and combine with various PV solar panels above, streets, junctions and using any other renewable alternative energy.

According to another embodiment of the invention, the mechanism of “electric fuel” and Electric Power Station Facility further comprises commercial/public areas provided with plurality of mechanism of “electric fuel” and Electric Power Station facilities that are adapted to gather DC energy from batteries of parked EV, EM, EB and charged/discharged via power stations as “electric reservoir/tank” (replacing, e.g. liquid fuels tanks storage in petroleum gas station tank), obtaining DC electric energy from distant locations with charged EV batteries, together with locally mechanism of “electric fuel” and Electric Power Station Facility located at residential, commercial, industrial workplace, herein called “electricity cable conductors”, and thereby enabling the transfer of electric energy from one place to another.

According to another embodiment of the invention, the mechanism of “electric fuel” and Electric Power Station Facility further comprises a mobile application with management software tool for managing DC or AC (Gradually changing the use to DC) power consumption and other services provided via said “electric fuel” electric power station.

According to another embodiment of the invention, the mobile application and the management software tool include managing electricity, hot water consumption, meters, rent/use vehicles, mechanism of “electric fuel”, electric power, video camera, hazard security, billing, and other needed services.

### BRIEF DESCRIPTION OF THE DRAWINGS

FIG. 1 schematically illustrates a mechanism of “electric fuel” and Electric Power Station Facility comprising; mechanism of smart upright horizontal robotic rotative two-floors elliptic carousel parking electric facility, electric charge/discharge/accumulate/exchange, that includes plurality of parking smart cabins configured for continuously charging/discharging DC or AC consumers through smart parking cabins, with pull/push device, according to an embodiment of the invention.

FIG. 2 schematically illustrates an upright horizontal paralleled two sides two floors elliptic carousel rotative conveyors mechanism, driven by an electric motor with mechanical gearbox, connected directly through central two-sided axis, activating gear system and/or chains, alternatively two side synchronized electric motor and from there to two side link chains conveyors multiple supports arms system that leads to plurality of said parking smart cabins, which are configured for Bi-direction continuously move around, according to an embodiment of the invention;

FIG. 3 A schematic illustration of electric motor mechanism, activate mechanical gear box which is connected to one side of the structure frame. The main mechanical gearbox is connected through coupling to central main two-sided axis and to sprocket wheel operating a gear system and/or a chain, which operates multi-arms elliptic link rolling chain conveyor system that is connected to main smart cabin axis, according to an embodiment of the invention;

FIG. 4 A schematic illustration mechanism of upright horizontal rotative, motorized side of two floors elliptic link rolling chain conveyors, shifting smart cabins in edge arc side reverse switching of two floors, according to an embodiment of the invention;

FIG. 5 A schematic illustration of mechanism of horizontal driven central main two-sided axis connected to sprocket wheel and from there to a gear system and/or chain and from there to mechanism of upright multi-arms chain conveyor system that is connected on one side to main smart cabin axis and on the other layer to a stabilizing metal beam, according to an embodiment of the invention;

FIG. 6 A local detailed section view of moving smart cabin axis (in various positions) connected to multiple upright supports arms elliptic chain conveyor system, that are connected to main cabin axis that is connected to horizontal stabilizing beams, according to an embodiment of the invention;

FIG. 7 A schematic illustration of improved slidable multi-axial rotational, multiple electric connectors (with double or more contact, to increase energy capacity transfer), electrically connected to parking smart cabin through improved busbars in upright two floors elliptic track rail including additional 90° two side multiple electric conductors, that are able to charge/discharge/exchange (without cessation) one or more DC or AC consumers, according to an embodiment of the invention;

FIG. 8 A schematic illustration of multiple electrical wires connecting between smart cabins to elliptic guide track rail carrier, divided in two sectors of horizontal robotic rotative parking facility, according to an embodiment of the invention;

FIG. 9 A schematic illustration of mechanism of smart multi-function cabin integrated automatic car washing machine, according to an embodiment of the invention;

FIG. 10 A schematic illustration of detailed view of smart parking cabin of mechanism of “electric fuel” and electric Power stations facility, integrated Security, Camera, Video, according to an embodiment of the invention;

FIG. 11 A schematic illustration mechanism of “electric fuel” and Electric Power Station Facility that is integrated with surrounded entrances and exits at least 2-sides and connected to several renewable energy sources, according to an embodiment of the invention;

FIG. 12 A schematic illustration of an exemplary implementation of; three horizontal and one vertical rotative elliptic robotic parking facilities, EV retractable mechanical arms, electric 360° rotatable table mounted on bi-direction conveyors, according to an embodiment of the invention;

FIG. 13 A schematic illustration of conveyor/mechanical arms configured to extract/retrieve vehicles from the rotative robotic parking facility main entrance/exit to plurality smart cabins in other robotic rotative parking facilities.

### DETAILED DESCRIPTION OF THE INVENTION

The present invention describes a stand-alone mechanism of “electric fuel” and Electric Power Station facility adapted to obtain electrical DC or AC (Gradually change the use to DC) power from alternative renewable energy. In addition, electrical power is received/exchanged/obtained from one or more batteries of one or more electric vehicles (EVs) parked in the upright horizontal parking facility or nearby. The mechanism of “electric fuel” and Electric Power Station Facility is capable of providing, without cessation, electrical DC or AC power to several power consumers, such as batteries of EVs (including Electrical Cars (EC), Electric Motorcycles (EM), Electric Bicycles (EB), electrical powered wheelchairs, etc.) and residential, commercial buildings, instruments and domestic appliances or any area, which consume and use DC or AC electricity (e.g. domestic or public LED light fixtures, computers, battery chargers, ovens, air conditions, refrigerator etc.) via DC or AC electric locally grid and DC electrical supply, as known in the art.

Charging at the same time various of EV batteries (including EC, EB, and EM) and providing DC or AC electrical power to other consumers requiring large amount of power, i.e. few hundreds of kWh, regardless of battery model and consumption. The mechanism of “electric fuel” and Electric Power Station Facility of the present invention is capable of providing sufficient amount of power, simultaneously to all smart cabins via smart ports to all EV and other batteries located in the smart upright horizontal robotic rotative two floors elliptic carousel parking electric facility. Traditional electricity network (exist today) is the main supplier of electricity both to EV batteries and to other electricity consumers. The object of mechanism of “electric fuel” and Electric Power Station Facility is to replace the traditional electricity network and its power sources (i.e. electric power plants). Moreover, as the growing interest in EVs results in an ever increasing market share, smart charging and discharging ports will, in the future, replace fossil refueling stations. The mechanism of “electric fuel” and Electric Power Station Facility of the present invention is capable of providing sufficient electrical power to large amount of EV both in robotic parking facilities and in street side parking spaces simultaneously. Electric energy exchange between EV batteries combine PV solar panels facility batteries with other renewable electricity and electricity consumers, will allow cancelation of traditional electric power stations plants and gas (fuel) stations.

The mechanism of “electric fuel” and Electric Power Station Facility comprises a mechanism of robotic rotative parking facility in which EVs (e.g., ECs, EMs, EBs) can be parked and be moved in upright horizontal elliptic manner, connected via one of plurality of parking smart cabins that are part of the horizontal rotative robotic parking facility, as will be described in details hereinafter. The electrical connection between EVs (such as ECs, Ems and EBs) and the upright horizontal robotic two-floors parking facility is appropriate for charging the batteries of EVs parked in the robotic parking facility, and to discharge accumulated electricity in EV batteries or other batteries.

According to an embodiment of the invention, electricity storage and accumulating systems (e.g. batteries, capacitors, thermal systems, etc.) accumulating electrical power produced for regular average uses, for instance, during daylight and when all EVs connected to the mechanism of “electric fuel” and Electric Power Station Facility are fully or partially charged. Electricity discharge for various consumption when not enough electricity is generated from PV solar panels, EV batteries and other renewable electric sources, such as at night time or on cloudy days. Usually in places that are cloudy, there are winds, which are generating electricity for daily and night charging energy.

According to an embodiment of the invention, generating electricity from; renewable energy, or batteries of EVs when exchange electric energy between EV batteries, buildings and houses, all together are managed by management and control software and mobile application, capable of taking in account plurality of parameters and determining accordingly optimal power supply configuration, for instance, in case a fully charged EV is parking in the robotic parking facility during the night, the management software is able to determine the amount of electric charge to EV battery when his owner needs in the morning, and accordingly determine the amount of electricity that can partly be discharged from another EV overnight and temporarily not in use.

According to an embodiment of the invention, the mechanism of “electric fuel” and Electric Power Station Facility provides electricity to other parking spaces that are not located in the robotic rotative parking facility of the mechanism of “electric fuel” and Electric Power Station Facility. Accordingly charging/discharging through smart ports, connected to the mechanism of “electric fuel” and Electric Power Station Facility, and exchange electric energy with nearby parked EV in street spaces.

The embodiments of the figures are not limited to specific location of the renewable energy electric supply, and they can be on any structure capable of carrying the weight. Places that are cloudy, normally there are winds, and seaweed energy which are alternate for daily and nightly charging energy.

According to an embodiment of the invention, parking with smart cabin is adapted to be occupied by plurality of objects.

It is noted that although robotic parking facilities are illustrated with specific number of parking cabins, when robotic parking facility according to the present invention is not limited to a specific number of parking cabins and may comprise two or more parking cabins in an upright two-columned robotic parking facility or in horizontal two-floors or more robotic parking facility, as explained hereinabove.

Buildings such as residential or commercial, electricity supply to consumers through “multiple cables, multiple voltage electric lines suppliers” (electrically powered from renewable or EV batteries electric energy) distribute to different consumers, using existing and separate electric junctions boxes, through fuses respectively through power electric cables circuits supply such as; 1. LCD lights. 2. Communication and USB. 3. Electric appliances, and various voltages in public and private areas electric circuits including also where needed additional electric junctions boxes integrated with smart apartment electric box management system.

The mechanism of “electric fuel” and Electric Power Station Facility provides several advantages over ordinary horizontal parking facility, as it provides rental/taxi station, bonded warehouse, economy exchange from ordinary fuel vehicles station to electric refueling stations and huge multiple accumulators on which parking facility is built; the smart cabins further comprise one or more storage units, thereby enabling the use of cabins as storerooms or as delivery mail boxes, and it offers more security. Parking in elevated position requires bringing the vehicle down to ground level to exit the parking facility; therefore it may be controlled by code and other security measures. All smart cabins and parking facility are installed with communications system via router (Wi-Fi or any other wireless or bi-direction data communications).

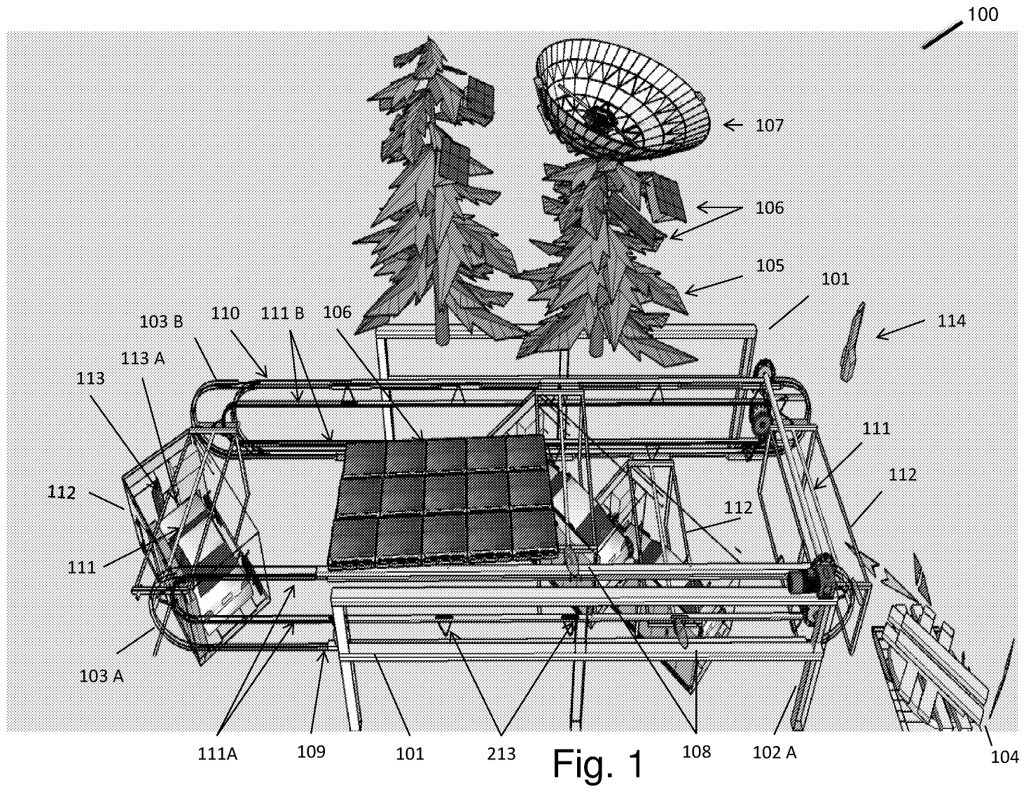

As may be seen from the illustration in FIG. 1 parking facility 100 comprises smart upright horizontal robotic rotative two-floors elliptic carousel parking electric facility, wherein “side by side” two metal structure columns main frame, supporting upright horizontal rotative two floors elliptic parallel two side link rolling upright arms chain conveyors, shifting between various positions either one or two floors, motorized by an electric motor gearbox, connected through central two-sided axis, transferring power to two sides link rolling upright arms chain conveyors gear systems.

In this embodiment, each smart cabin 112 is connected to link rolling chain conveyors 111A, 111B by mechanical supports arms which are connected to tubed axis 111 located on top of each smart cabin 112, and on its tube axis edge they are connected to multi-arms 213 chains. The upright paralleled two floors elliptic conveyors 111A and 111B consequently shift smart cabins 112 from one position along robotic parking facility 100 to another position to allow EVs entrances and exits to and from parking facility 100 independently or through unit 102 (e.g., positioned at ground or half level entry/exit).

Smart cabins 112 are capable of charging/discharging/exchange electric energy without cessation (as long as an EV remains electrically connected to smart port 113 by cable plug connector 113A or wireless induction). Furthermore, each smart cabin 112 comprises sufficient space for accommodating plurality of EVs, i.e. an EC, one or more EMs and/or one or more EBs, all in one smart cabin.

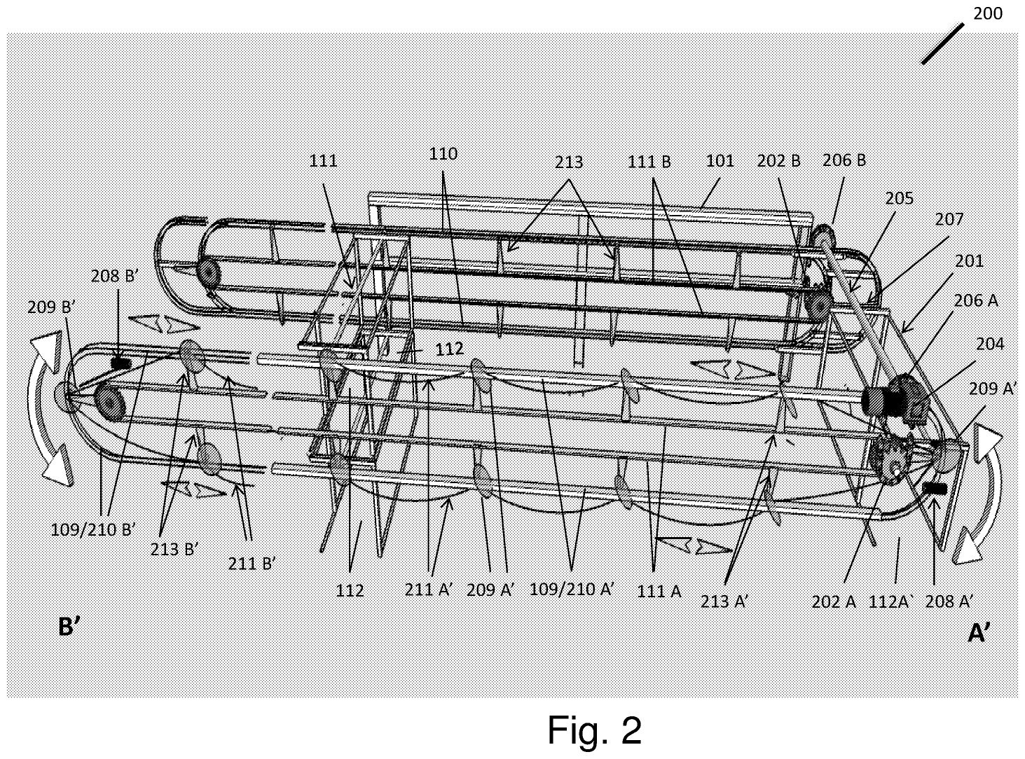

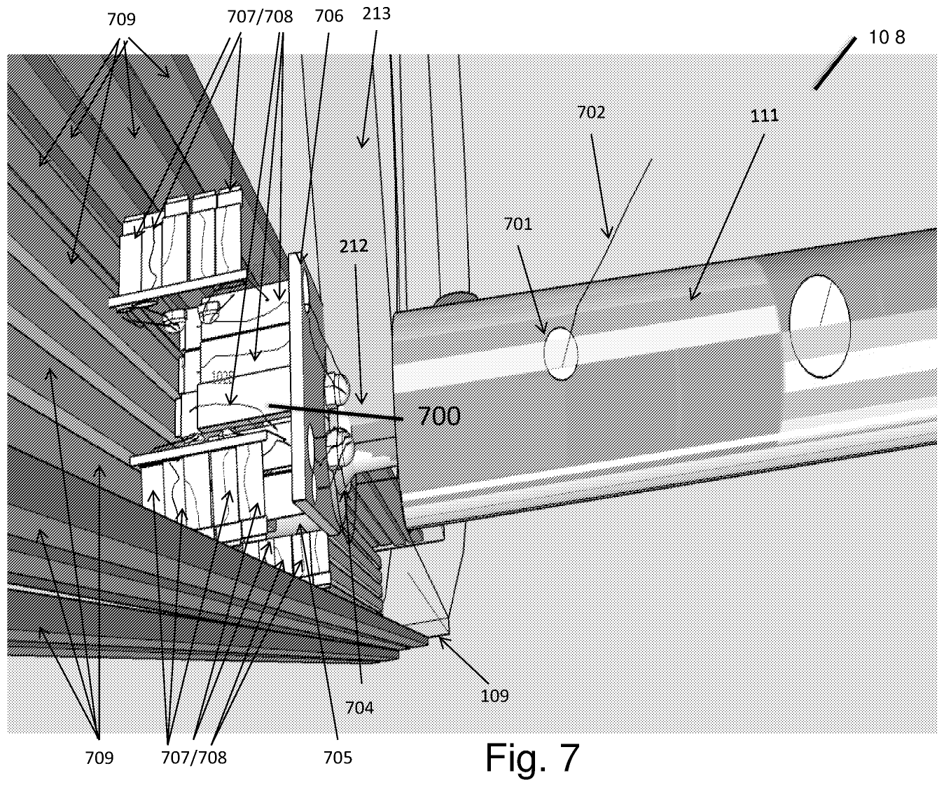

An elliptic guide track rail carrier 109 (FIG. 2, 4,9) is installed parallel to upright conveyor 111A, consists/through electrical busbars conductors track rail 709 (FIG. 7) connected to slidable multi-axial rotational, multiple electric connectors 108 (highlighted), starting from the main entrance side 102 A lengthwise to back side 103A of elliptic guide track rail carrier 109. Two upright link chain conveyors 111A and 111B are capable of rotating both clockwise and counterclockwise.

In this embodiment, the circular motion is bidirectional. Two paralleled upright two-level elliptic conveyors 111A and 111B, attached to supporting frame structure 101 of parking facility 100.

In this embodiment, guide track rail carrier 109 comprises an isolated guide electrical rail busbars conductors 709 (FIG. 7), having an elliptical form. busbars 709 is made of metal conductors (e.g., cooper) and deploys therein an elliptic mode along the upright structure of guide track rail carrier 109. busbars 709 configured to concentrate and distribute electrical power throughout parking facility 100. busbars 709 are adapted to transfer high voltage Direct Current (DC) or AC, via slidable connectors 700 (see FIG. 7), to and from parking facility 100 and in particular to and from the charging/discharging exchange energy through smart port 113 of smart cabin 112. by horizontally upright track rail 110 at any position and on the edge arc entrance/exit changing direction through split forked guide track rail 110/1 and 110/2. The same procedure is done at the back side 103B (FIG. 1) of chain track rail 110. For illustration purposes, stabilizers beams 207, axis 111, and arms 213, may be seen at different positions in the rotation arc/swivel area.

In addition, parking facility 100 include managing software and electric/electronic box system 114 (e.g., that may be located at the entrance to parking facility 100) for managing the usages and services applied to each parking vehicle, such as billing, payments, and balancing between meters (e.g., exchange energy between simultaneously charging and discharging modes).

In this embodiment, PV solar, CPV 106/107, and artificial PV solar 105, are connected to the robotic parking facility 100 directly and in close proximity. On top, another solar electric supplier HCPVT or 4-DCPVT (four dimension concentrate photovoltaic thermal) 107 are connected.

According to another embodiment of the invention, two sides upright horizontal rotative conveyors 200 are shown in FIG. 2. Parking facility 100 comprises two upright conveyors 111A and 111B having an elliptic form, connected to upright metal frame bases 101, side A is connected to electric motor with gearbox transmission 204, central motor gearbox shaft 204 is connected to gear wheel 206A, which transfers power to an additional gear wheel system 202A, which activates the entire elliptic chain conveyor 111A connected to multi-arms 213. On the opposite side, gear wheel 206B is installed and connected through coupling axis 205. Under gear wheel 206B, installed and connected is gear mechanism 202B that transmits the power to elliptic conveyor 111B which is connected to multi-arms 213, alternatively two sides synchronized electric motor. With stop station to loads/unloads vehicles in mid distance between upper and lower (partially horizontal) conveyors, or beyond horizontal conveyors 111A arcs (curves), at arm edge 213 connecting central axis 111 of smart cabin 112. Alternatively, electric motor gearbox 204 may be installed on one side between two horizontal elliptic conveyors layers 111A and its axis (shaft) 205 mounted the crossing between conveyors 111A and 111B layers,

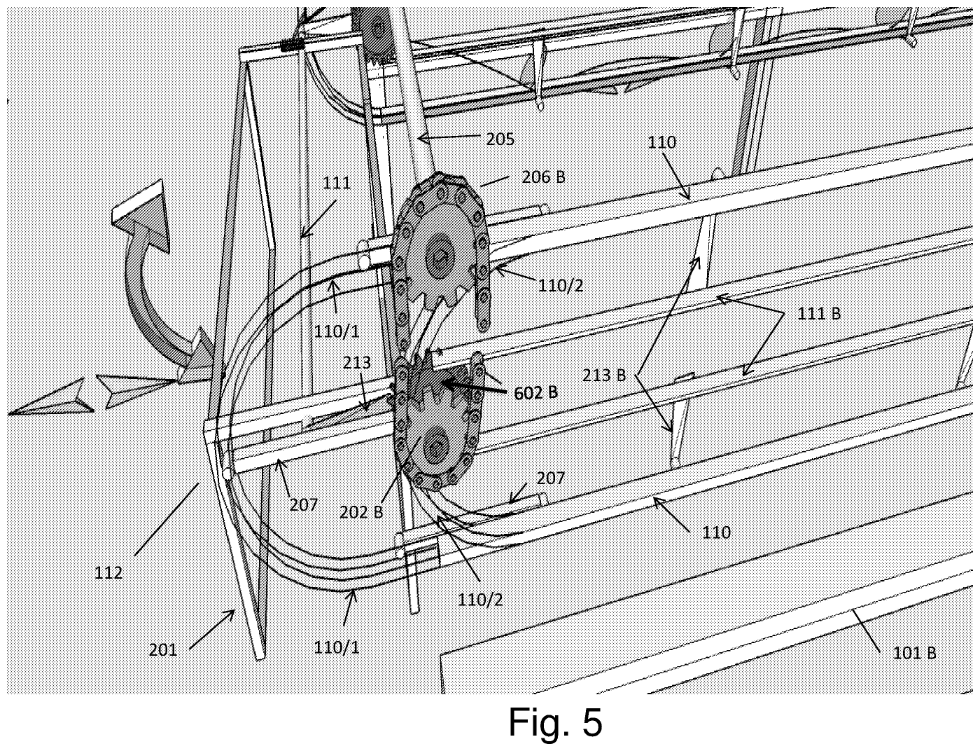

The same structure exists on the opposite side connected to arms 213, attached to the central cabin axis of plurality smart cabins 112. In side B at the edge end of axis 111, horizontal stabilizer beam 207 is connected for shifting smart cabins 112 vertically. Stabilizer 207 is connected to axis 111 of smart cabin 112 and on the same surface frame 201 is attached to smart cabin 112. Cabins stabilizers 207 are built of steel beams on its edges connecting sliding guiders to prevent vibration and horizontal steering of smart cabins 112 while shifting on conveyors 111A 111B. In the elliptic conveyors ends, during reversal direction, stabilizer 207 is stabilizing smart cabin 112 that hangs on bearing 212 (see FIG. 7) and arms 213 between conveyors 111A and 111B. Stabilizers 207, are guided horizontally along Elliptic track rail 110 and smart cabin 112 moves horizontally and kept upright between another smart cabin 112, the same is kept vertically and respectively at elliptic track rail 110 ends, when specially needed in fork arc guides 100/1 and 100/2 (FIG. 5) ends when switching to return direction.

As described hereinabove another alternative of decentralization and distribution of electricity to smart cabins 112, is shown in FIG. 2. main electric power supply electric power to subdivide sector electric power box junction 208, both sides are individually connected through multi-wire electrical cable and placed on elliptic guide track rail carrier 109, the cables are then split into two equal sectors, Side A′ sector spiral cable 210A′ and side B′ sector spiral cable 210B. The cables are positioned in U shape along guided track rail 109.

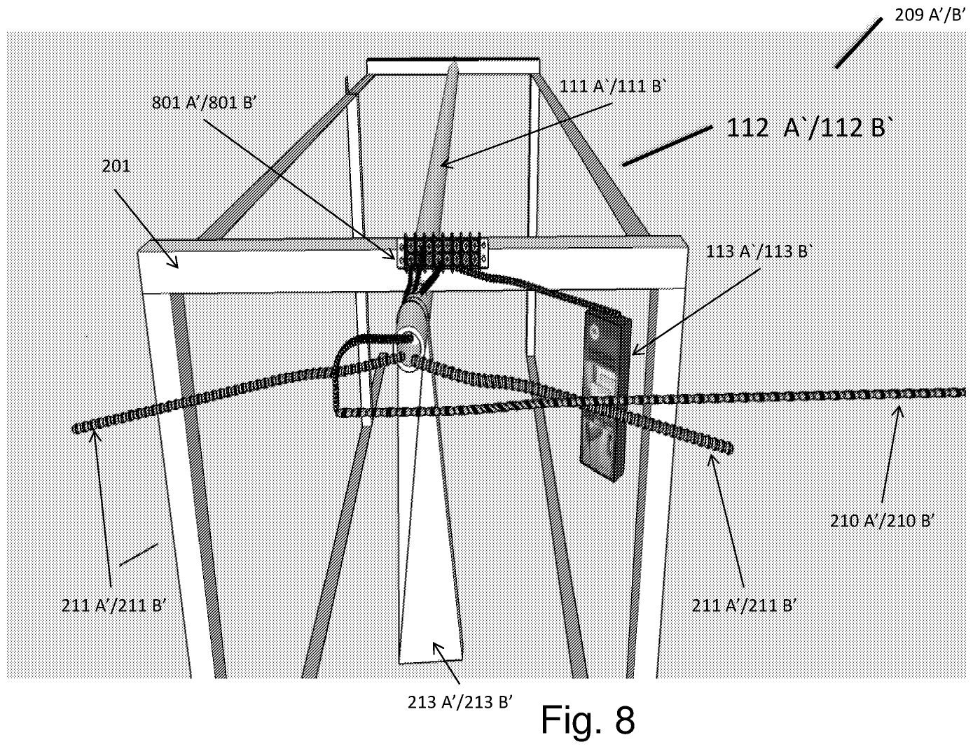

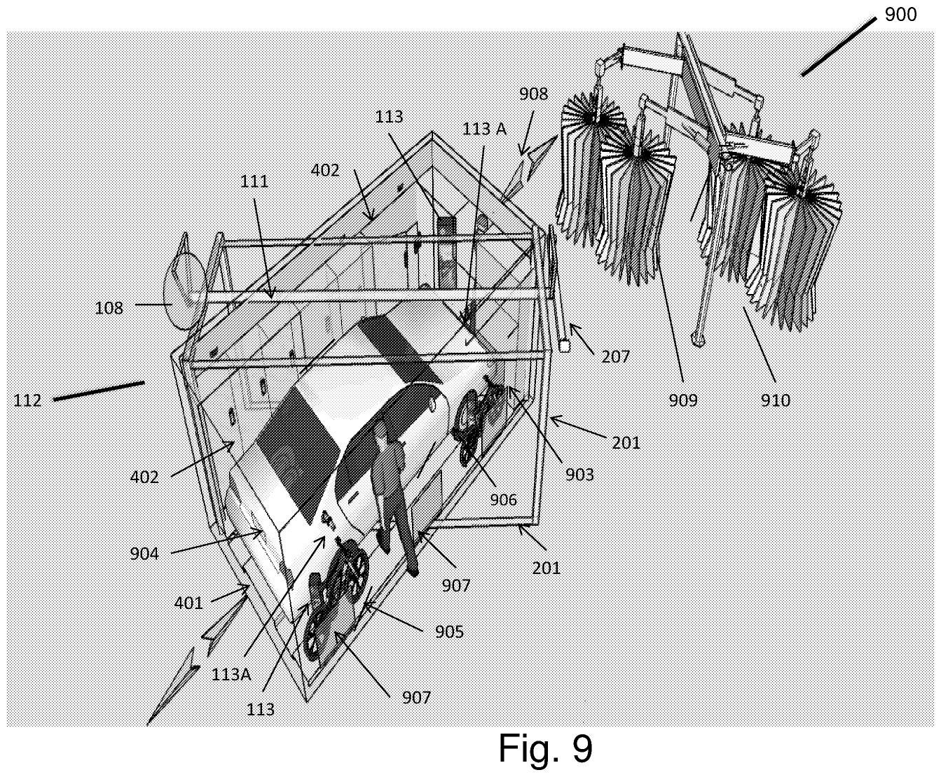

Each sector is connected respectively to the middle at an equal distance from each sector (A′ or B′) of multi-arms 213A′/213B′ system that lead to plurality of parking smart cabins 112A′/112B′. Respectively additional spiral cables 211A′/211B′ are connected and hanging among smart cabins 112A′/112B′ when shifting the cabins 112A′/112B′ from one position along the mechanism of robotic parking facility 100 to another position in an elliptical formation that corresponds to guide track rail carrier 111. Highlighted 209A′/209B′ emphasis electric junction, are shown in FIG. 8. Spiral cable multiple electric wires 210A′/210B′ are capable to transfer high-voltage and high current DC or AC, appropriately voltage capacity of sixteen or more electric multiple copper wires that each (individual) electric wire may transfer around ˜1000 volt DC ˜250AMP and more, supplied from various sources (e.g., MPVP (Multi Photovoltaic Panels), Multi HCPVT (High Concentrated Photovoltaic Thermal), CPV, PV Panels, and other Alternative renewable Energy), so that for applications that may require higher electric power energy, more multi-wire cable may be used. Each time an EV enters or exits from robotic parking facility, each sector A′ or B′ must return back to their previous zone position before any further action.

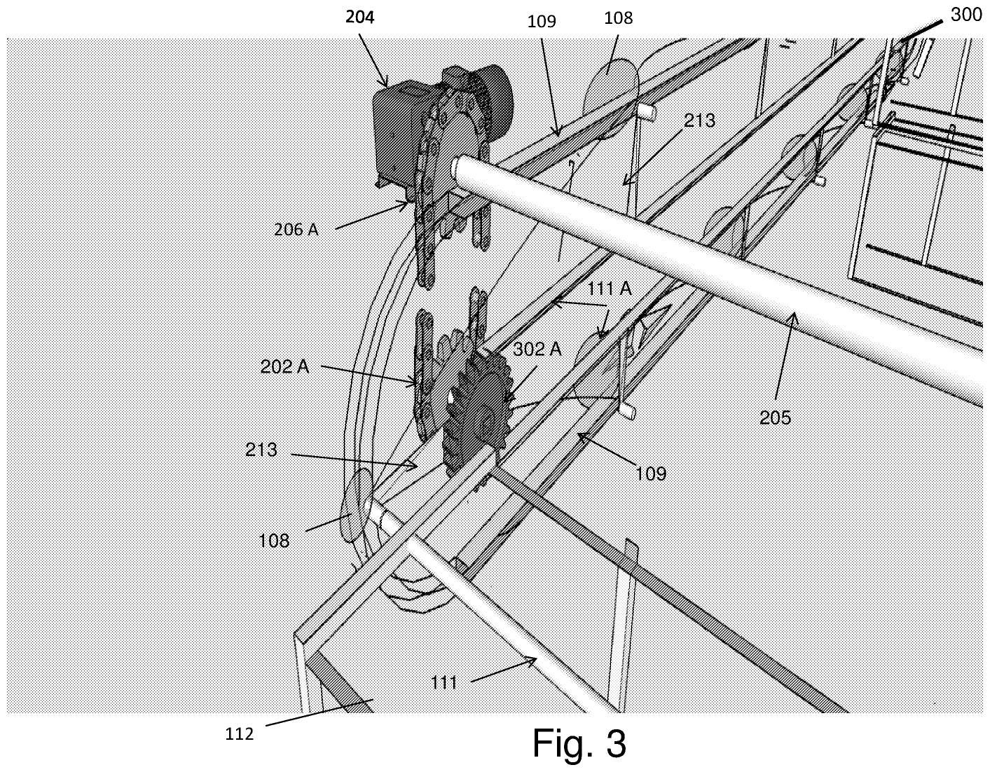

A shown in FIG. 3, mechanism 300 of electric motor mechanism is shifting movement to mechanical gearbox 204 (FIG. 2). Mechanical gear box 204 is connected to one side A of support structure frame 101. Central gearbox shaft 204 is connected through direct coupling connector to central main two-sided axis 205 and overlapped with sprocket wheel 206A and from there motorizing sprocket wheel (e.g. chain) 202A connected to axis, which are connected to main conveyor 111A through sprocket wheel 302A.

Link chain conveyor 111A is connected to sprocket wheel 302A and at fixed intervals connects multi-arms 213 to elliptic chain conveyor 111A system. On the other side of arm 213, bearing 212 is attached (FIG. 7) to main smart cabin 112 at axis 111 edge A attaching multiple axial rotational electric connector 700 (FIG. 7) which slide between two busbars conductors guided walls, through elliptic guide track rail carrier 109, The same procedure is done at the back side 103A (FIG. 1) of chain conveyor 109.

Detailed upright layers/surfaces, along horizontal frame structure 101A;

Upright layer/surface 1.; sprocket wheel 206A and sprocket wheel (e.g. chain) 202A are on the same layer/surface.

On second parallel upright layer/surface 2. (between layer 1. and layer 3.); elliptic guide busbars conductors track rail carrier 109 (FIG. 1)

On third parallel upright layer/surface 3.; fitted main conveyor 111A with sprocket wheel 302 A, on sprocket wheel 302 A and at fixed intervals, connected link chain with multi-arms 213,

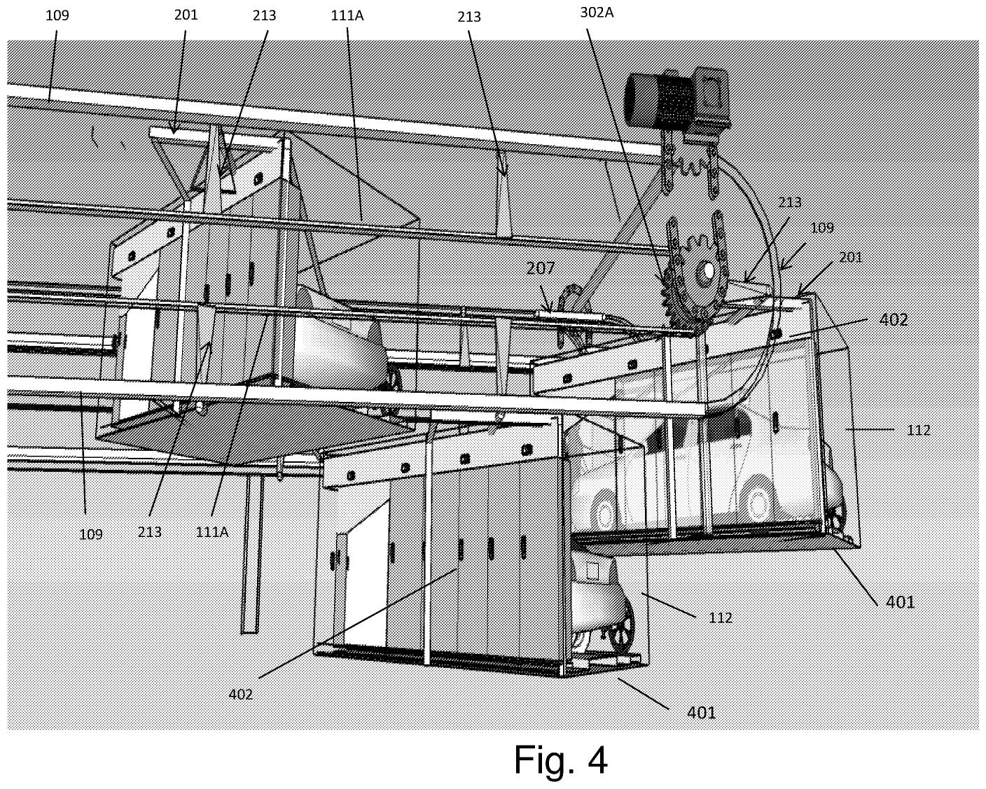

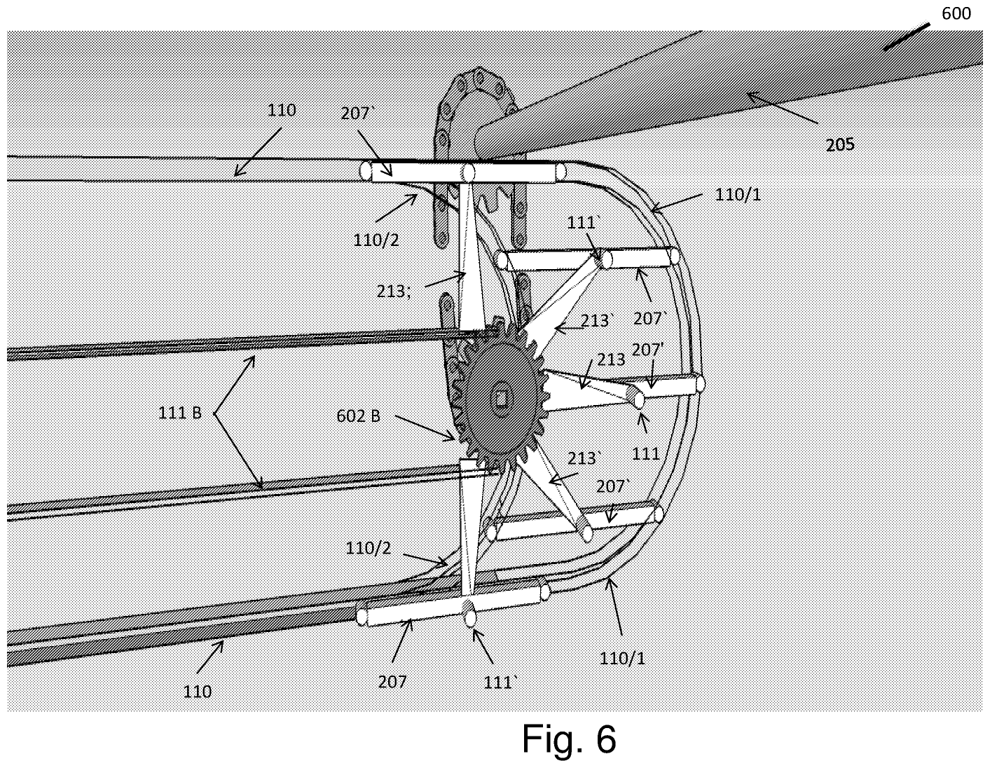

FIG. 4 shows a mechanism of horizontal rotative two layers of elliptic link rolling chain conveyors, shifting smart cabins 112, which are adjacent and located at distance from each other corresponding to arms 213 length, which are mounted (installed) in link rolling chain conveyors 111A and link rolling chain 111B through central axis 111 of smart cabins 112, maintaining supports arms 213 length ratio relatively to motorized chain sprocket or gear wheels 302A and 602B (see FIG. 6) diameter, depending on quantity and sizes of smart cabins 112, comprising variety of different tilted angles between main structure frame 201 (FIG. 2) of smart cabins 112 and 0° to 90° degrees parallel or serial (e.g. 30° 45° 60° degrees) relative to vehicles platform support structure frame 401 (consist with EV,EM, EB, charging ports 113 and storage boxes 402)

According to an embodiment of the invention, when the parking system is installed in places of small parking width facility, the one or more cabins installations are selected from the group consisting of: variety of different tilted angles between main structure frame 201 of cabins 112 relative to vehicles platform support structure frame 401 (consist with EV,EM, EB, charging ports 113, storage boxes 402) (FIG. 4) and, 0° to 90° degrees parallel or serial (e.g. 30° 45° 60° degrees). When smart cabin 112 at any position and reverses direction at the end of conveyors 111A, 111B and elliptic track rail 110, the horizontal stabilizers beams 207 (FIG. 2, 6) is located in the track rails arches area and is supported by tracks railings 110/1, 110/2 Releases between cabins 112 stabilizer beam 107 and the tracks railings 110/1, 110/2 are needed to stabilize the cabins, during vertical transfer. Therefore sliding surfaces (e.g. Teflon) are installed at the end of conveyors 111A, 111B and between cabins 112 to eliminate any friction.

FIG. 5 shows the mechanism of rolling chain conveyors 111B motorized from central main two-sided axis 205 (FIG. 2) connected to sprocket wheel 206B connected to one side B of the structure frame 101B (For demonstration purpose, parking facility structure was moved beside), and overlapped with sprocket wheel 206B and from there carried to sprocket wheel chain 202B, sprocket wheel (e.g. chain) 202B connected to axis which is connected to main link chain conveyor 111B through sprocket wheel 602B (FIG. 6), to sprocket wheel 602B, attached to elliptic link rolling chain conveyor 111B and at fixed intervals connects multi-arms 213 B, to elliptic chain conveyor 111B system, on the edge side of arm 213 B, attached bearing 212 (FIG. 7) that is connected to main cabin axis 111 and leads to smart cabin structure 201, at axis 111 edge B, connected to horizontal cabins stabilizers beams 207 and conveyed horizontally by track rail 110 at any position and on the edge arc entrance changing direction through split forked guide track rail 110/1 and 110/2. The same procedure is done at the back side 103B (FIG. 1) of track rail 110.

Detailed upright layers/surfaces, along horizontal frame structure 101B;

Upright layer/surface 1.; sprocket wheel 206B and sprocket wheel chain 202B are on the same layer/surface.

On second parallel upright layer/surface 2 (between layer 1. And layer 3.); elliptic guide upright track rail 110 for horizontal upright cabin to shaft 111 connected to horizontal stabilizer beam 207

On third parallel upright layer/surface 3.; driven main conveyor 111B with sprocket wheel 602B, to sprocket wheel 121B and at fixed intervals connected multiple upright supports arms 213.

FIG. 6 shows a local section view 600 side B (driven by shaft 205) main entrance comprising upright horizontal conveyors 111B and track rail 110 installed side by side in parallel (on different upright level/layer), at the ends of upright conveyor 111B, an arc shape guider is connected respectively, which together complete the elliptic rolling chain conveyor 111B system. On the other side of arm 213, a bearing is attached connecting to main cabin axis 111 and at axis 111 edge B is connected to horizontal upright cabin stabilizer beam 207 guided by horizontally upright track rail 110 at any position and on the edge arc entrance/exit changing direction through split forked guide track rail 110/1 and 110/2. The same procedure is done at the back side 103B (FIG. 1) of chain track rail 110. For illustration purposes, stabilizers 207, axis 111, and arms 213, may be seen at different positions in the rotation arc/swivel area.

FIG. 7 shows local section view of improved Application IL251245, which withstand in electric heavy-duty, refers to multiple-axial and plurality of slipping's connectors/conductive 700 and interaction with plurality sides of busbars conductors 709 may consist of:
improved by at least doubling coupled electric rotary slips rings connectors 705 (e.g., SR004 series electric slips ring by Rotary Systems, Inc.).
improved by at least doubling coupled metal (e.g., copper, graphite) & brushes slips conductive 708 and which are mounted on both sides up and down of the rotary multiple slips rings connectors 705, that are adapted to slide respectively to conductors of bidirectional electric busbars 709 with additional (e.g. 90°) two sides of busbars conductors, are adapted to slide on at least 3-systems arrays/formation of conductors of busbars transferring and distributing electricity continually without cessation (e.g., in the SR004 model through electric cables entry conduit cable and fitting 707 for conducting current between the cables and the moving parts).
improved by at least doubling coupled conduit cable and fitting 707 are used as a pathway for delivering high voltage DC or AC & signal data.
In this embodiment, rotary electric multiple slips rings connectors 705 located in center axis 111 with hole at the edge, comprising hole 702 where power & data cable 701 and (e.g.; carbon) brush conductors/connectors 708 enter in a way that its rear side faces the conductors of busbars 709 and its front side faces smart cabin 112 and it is connected to main cabin central axis shaft 111 of this cabin and Rotary multiple slips rings 705 continually providing super high electric power energy DC or AC via multi-electric connectors (i.e. copper, metal leaf, touching circle copper) (e.g., may include around sixteen or more electric connectors high voltage & low data connectors).

An anti-rotation bracket 706 (e.g., an integral part of rotary slips rings connector 705) is connected to axis 111 ring bracket mounting 704 contains 2 elements; is used to hold the metal (e.g., copper) & brush slipping connector 707/708 and between guided through elliptic guide track rail carrier 109 (FIG. 1)., and bracket 706 is connected to the metal cover housing of rotary electric slips rings connector 705 (bracket mounting), in addition attached to the anti-rotation bracket 706 slipping guided metal.

Additional option of upgrade/improvement; for connectors 700 and electric busbars 709 conductors with similar configuration, another possibility for an alternative electrical conduction system, through electromagnetic induction fields (without direct contact/touch), mounted on elliptic guide track rail 109.

In order to meet the high requirements of the supper high electric power supply energy demands, and continue operation of all smarts cabins, smarts ports, charge, discharge plurality of voltages with meters and management systems used in, the mechanism of “electric fuel” and Electric Power Station Facility which are at least 250 KWh and above for each smart cabin, when electric energy is transferred to each single EV battery, in the mechanism of “electric fuel” and Electric Power Station Facility there are simultaneously (at least 6-16 or more) EV, the management controller system accomplished the control/exchange/fluctuation, moreover operate the mechanism of “electric fuel” and Electric Power Station Facility electric, simultaneously create an electric connection/transfer/exchange energy between connector 700 and electric busbars 709 conductors. e.g.; the electrical energy passes through and alternates/exchanges at least 1-2 or more electric bars (from busbars conductors 709) and at least 1-2 or more brush slipping connectors 708 from connector 700 circulating/generates simultaneously charging/discharging/exchange of electrical energy.

FIG. 8 shows novel chained electrical cables multiple electrical wires, connected between smart cabins 112 to upright two floors elliptic guide track rail carrier, divided in two sectors of robotic rotative parking facility (108A in FIG. 2). Robotic parking facility 100 divides into two sectors A and B, i.e. multi helical/spiral cable (option for flat cable) with multiple electric wires 210A placed on elliptic guide track rail carrier 109, cable 210A′ entering through center hole in axis 111, which connects to upright supports arm 213A with bearing, cable 210A connected to first main station centralizer and coordinator of sector A electric power box junction 208A, sector A central electric power box junction 208A distributing through additional splitting, which carry out in two opposite directions. On one side there are several smart cabins 112A connected through multi helical/spiral cable with multi electric wires 211A, and on the other side, connected through multi helical/spiral cable with multi electric wires 211A are the second part of smart cabins 112A. Each individual smart cabin 112A and 112B comprising smart port 113 together connected to subdivide centralizing electric power box junctions 801A in sector A.

The same functioning (procedure) as in sector A exist in sector B through cable 210B connected to subdivide centralizing electric power box junction 801B, multi electric wires 211B and multi arms 213B respectively incorporate together and individually, are motivated from uptight horizontal two floors elliptic multi-arms 213A/213B and central smart cabins axis 111, connected to horizontal elliptic rolling chain track rail carrier 111A. Each or double (for high electric energy transfer e.g. 250KWh and more) are adapted to carry on multiple electric conductors wires corresponding, which high voltage DC or AC is being transferred to the smart cabin 112A/112B smart port 113A/113B.

As described hereinabove; In the middle of the robotic facility 100 on elliptic upright guide track rail carrier 109, an electrical junction box is installed inside main control box 114 (see FIG. 1) for branching off and connecting the electric power cables for the purpose of distributing electrical energy between smart cabins 112.

FIG. 9 shows novel integration 900 of smart cabins 112 and automatic car washing machine 910, when platform support structure frame 401 (FIG. 4) positioned in tilt, according to the requirements and shifting on horizontal conveyors 111A and 111B, detailed view of parking cabin 112 adapted to be occupied by plurality of objects. Parking smart cabin 112 further may comprise (around vehicle in 3 positions and above EV 904), storage boxes/element 402 (FIG. 4) for various uses, e.g. shops merchandise, apartments goods, stock, and drop-off station for postal packages. All EVs located in smart cabin 112 may be charged, previous charged consumers and discharged even when the electric vehicles smart cabins are rotating or in stop position continuously and without cessation, simultaneously from variety of connection smart ports 113 (EV, EM, EB). Smart cabin 112 includes an Electrical Car 904 and an Electrical Motorcycle 905, Electric Bicycles 906 that are both connected to continually charging and discharging smart ports 113 connected through plurality of electric DC or AC car charge/discharge smart plugs connectors 113A, to decry charging time and increase high current demands, an optional plugin consist, built-in 2-3 or more electric wires with 2-3 or more electric isolated connectors, designed to distribute the high electric currents in separate power cables within the EV for separate individual batteries, installed in different zones of the EV.

According to an embodiment of the invention, the charging and discharging of EV batteries can operate in various modes for exchanging electrical power, for example the battery of EV 904 may be used to charge the battery of EM 905, EB 906 or any other EV in the same robotic parking facility. Surface barriers 907 and smart ports 113 are designed for supporting, as rail guide and security spacers for EM 905, EB 906 from other objects (e.g. cabins, EV etc.)

Smarts cabins 112 are capable of accommodating vehicles, specifically EVs. Furthermore, each of the smarts cabins 112 comprises sufficient space for accommodating plurality of EVs, i.e. an EC, one or more EMs electric motorcycle and/or one or more EBs electric bicycle, Electric powered wheelchairs and like all in one smart cabin 112. Parking smart cabin 112 further comprises storage elements for various uses e.g. shops merchandise, apartments' goods, stock, Collecting station for Packages sent by post (the entire central controller unit, manage the collection/delivery) 114. EVs 904 can be charged, previous charged consumers, discharge at the same time as EVs, EMs, EBs, electric wheelchairs and the like) 904 and other rechargeable, dischargeable electric systems from variety of charging, discharging smart ports 113. The charging, discharging EMs EBs smart ports, designated to allow also to use as supporter and separator from parked EVs, and EMs, EBs parking in a parking space with automatic Bidirectional and vice-versa charging, discharging station.

According to an embodiment of the invention, parking facility 100 may further comprise an narrow installation, When needed in narrow places, when cutting off the four edges structure frame 401 (include storage boxes 402), allowing installation in places where the width of small parking facility is required.

According to an embodiment of the invention, parking facility 100 may further comprise an automatic car washing machine 910 (see FIGS. 3,7 and 8) that is powered by DC or AC electricity originating from the mechanism of “electric fuel” and Electric Power Station Facility electricity sources (i.e. EV batteries and solar panels). Car washing machine 910 comprising automatically loading an EV that is parked in smart cabin 112, for example, under washing machine 910, installed include mechanism 909 for automatically retrieving vehicles from cabin 112 of parking facility 100, and transferring it through an automated washing process within washing machine 910. Upon completing the washing process, the vehicles are automatically returned into smart cabin 112 of parking facility 100, alternatively, the car wash mechanisms are integrated/adapted into the mechanism of “electric fuel” and Electric Power Station Facility frame.

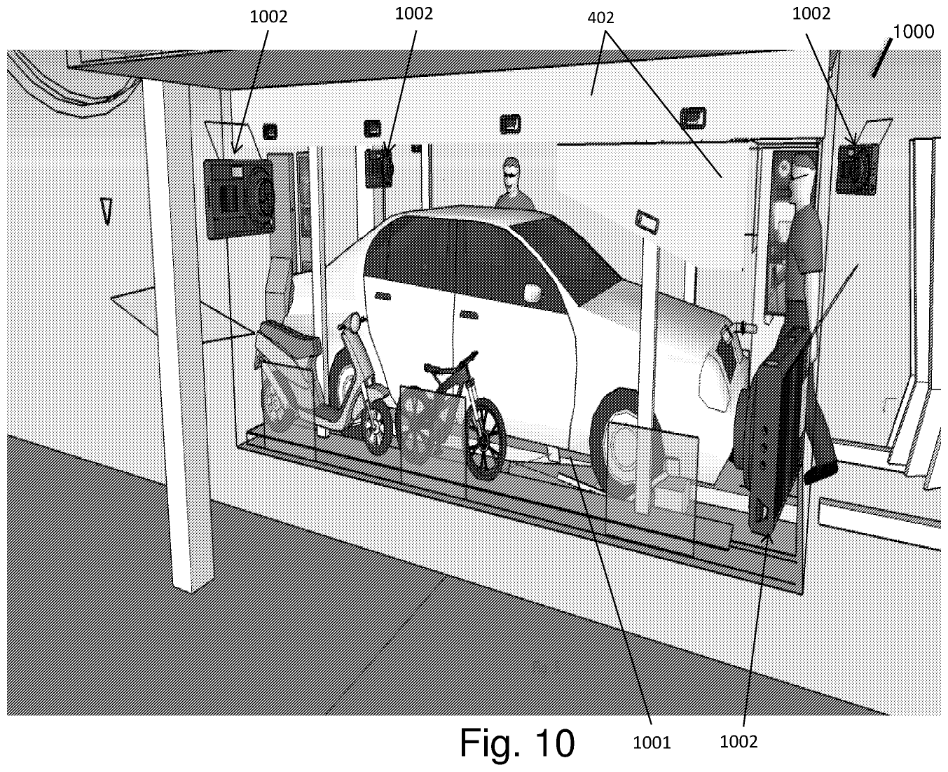

FIG. 10 shows a detailed view of parking cabin 112 populated with Vehicle 904 (FIG. 9), surround with several video cameras 1002 for security, survey and additionally hand mobile (moved into the center interior vehicle) panoramic camera/video 360° degree 1002 installed to capture the interior of the vehicle for different uses (e.g. rent, taxi, time share, autonomous vehicle, etc.), novel charging/discharge smart ports 1001 such as for example those disclosed in Application IL251245, With an improvement in charging/discharging time, amplification and distribution of the electric current in between EV batteries zones, alternatively integrated with approaching pull/push arms with multiple electromagnetic induction contact fields or surface are increased and split into 2-3 or more charge/discharging zones in individual EV batteries zones. Security, Camera, Video, storage element, boxes 402, according to an embodiment of the invention;

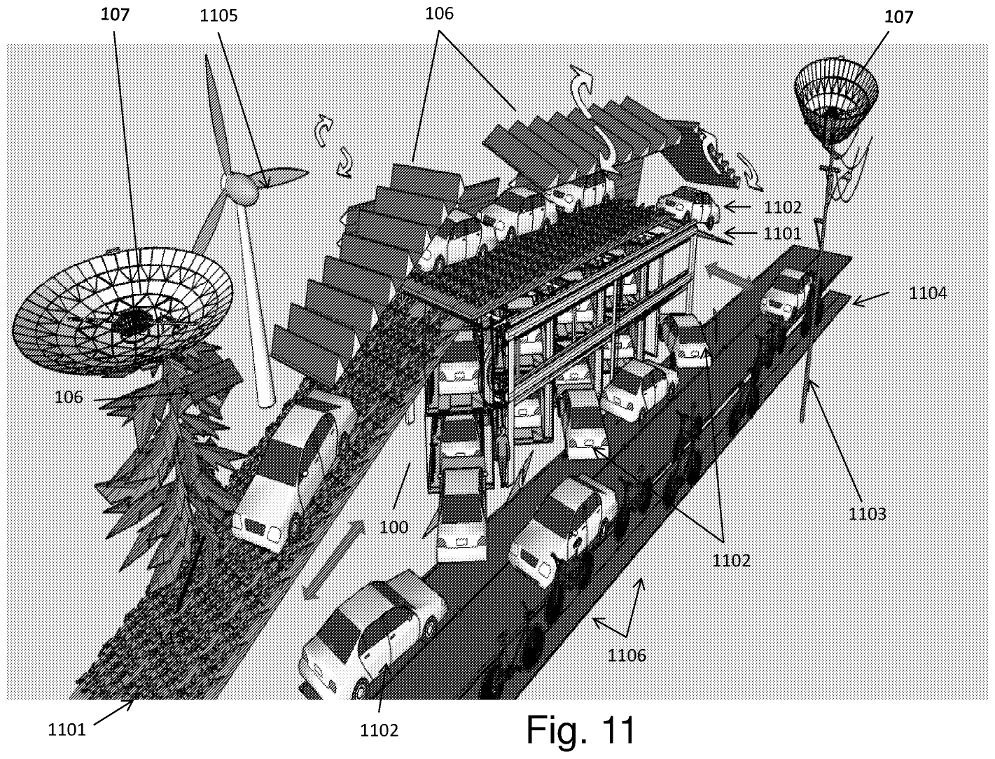

FIG. 11 shows an environment improvement, using mechanism of independent “electric fuel” station electric power supply stations facility mechanically operated with smart upright horizontal robotic rotative two-floors elliptic carousel parking facility 100, allowing upright parking smart cabins 112 to be shifted between various positions (in this embodiment, on either one of two floors), to be shifted between two floors on two side metal structure columns. Entry or exit of vehicles from horizontal parking facility allows, with or contrary to conveyor directions at different angles θ-90° degrees, another possibility, simultaneous another entry comprising side individual entrances and exits at least 2-sides different angles 0°-90° degrees to all of sides parking facility entry openings, to each smart cabin 112 separately, located on the lower level (ground surface), as it sow in each side vehicles 1102 are showing bi-direction (in-out) access to horizontal robotic parking facility 100.

The upright horizontal robotic parking facility 100 comprises installation of synthetic grass-like (artificial) hard surface 1101 (or any other material) on which additional vehicles 1102 may be parked above and alternatively, it can be used respectively for playground above of horizontal robotic parking facility 100, moreover adapted two access slopes 1101 are installed at both ends of the mechanism of “electric fuel” Electric Power Station Facility (bi-direction access), wherein vehicles identification sensors with electronic screens, detectors, are used for safety proposes at all entrances/exits to the smart upright horizontal robotic rotative two-floors elliptic carousel parking electric facility, moreover receiving electricity from above exist ultra-high/high pylons 1103, mounted solar and PVP electric supplier HCPVT (high concentrated photo-voltaic thermal) 107. Evacuate pathways from parked vehicles and create additional roadside parking space area and provide alternative pathway parking spaces 1104 spaces for EB or Pedal Bike 1106, another electric source from winds turbine, generating electricity for daily and night charging energy 1105.

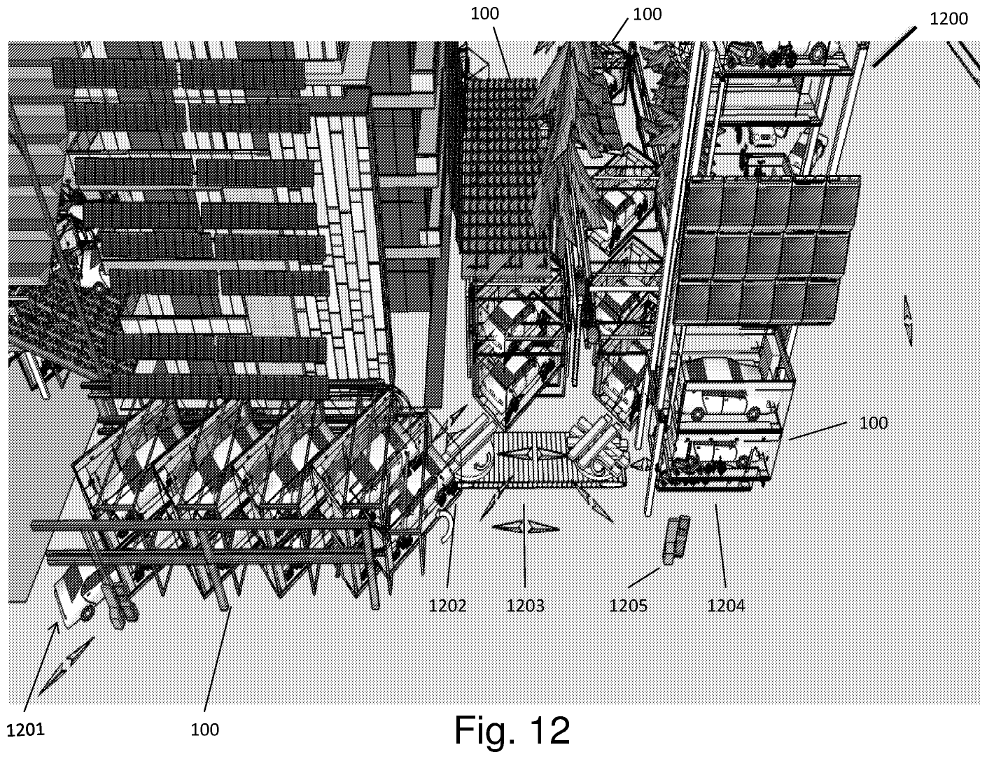

FIG. 12 shows an adjacent environment, robotic rotative parking facilities are installed in various combinations partially or fully under-ground from zero level surfaces adjacent to building, moreover on top of building roof, moreover combination of main entrance and exit 1201 marked with arrows 1201 to mechanism of “electric fuel” Electric Power Station facilities 100/1202. In the opposite side of parking facility 100 in exit 1202, adjacent horizontal conveyor with retractable mechanical arms 1203, are adapted to transfer vehicles back and forth from facility 100 to facilities entrances, and forward them also to and from vertical robotic rotative parking facilities 1204.

mechanism of “electric fuel” and Electric Power Station Facility 100, includes managing software and electric/electronic box system 1205 (e.g., that can be located at the entrance to first parking facility 100) for managing the usages and services applied to each parking vehicle, such as billing, payments, and balancing between various meters (e.g., between charging and discharging modes and etc.).

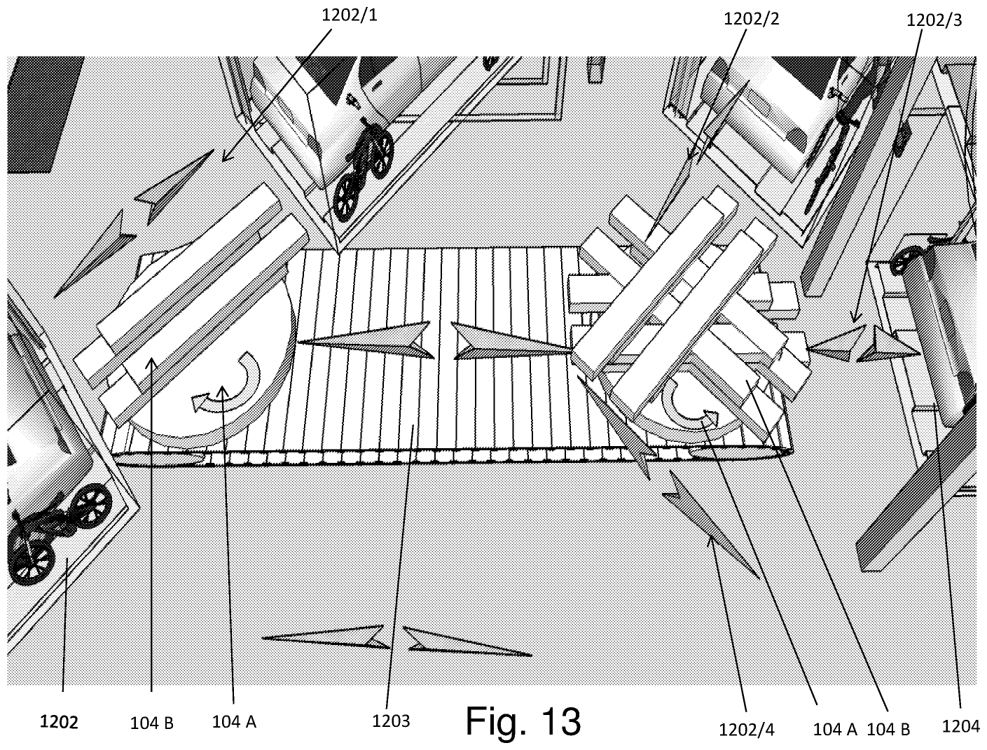

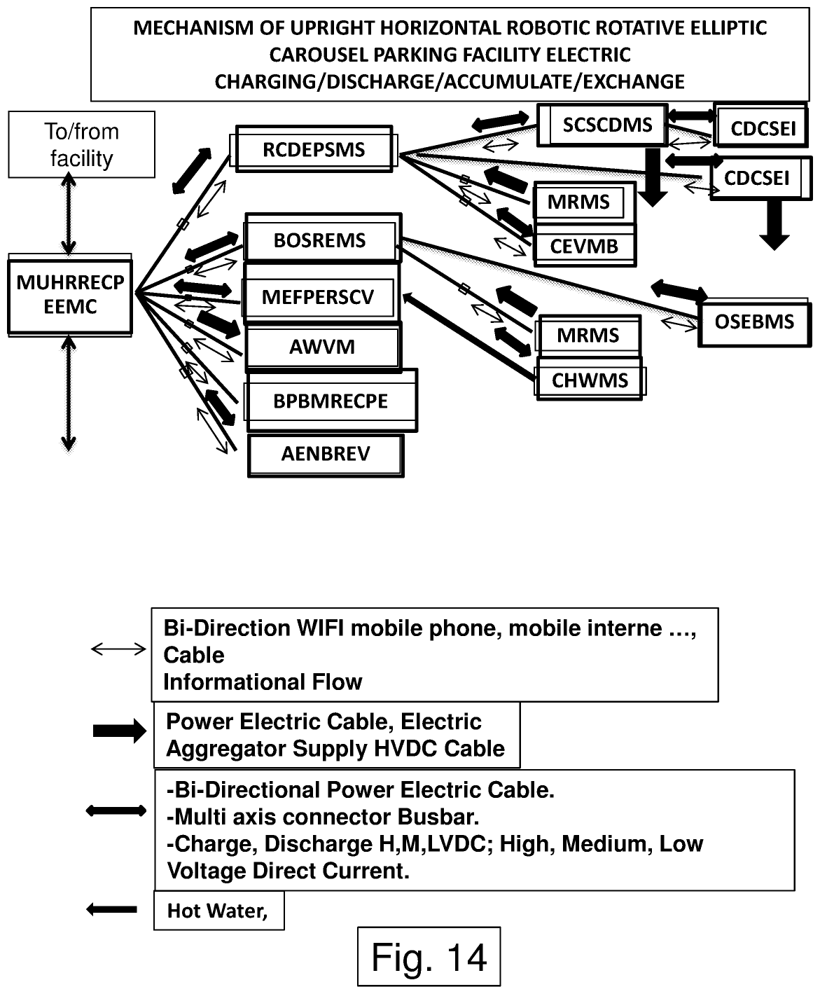

As described hereinabove, FIG. 13 shows in details improved multiple functioning conveyor/mechanical arms 1203 unlimited configurations to extract and retrieve vehicles from smart cabin 112 from first rotative robotic parking facility exit (e.g. 100), and convey the vehicles to plurality smart cabins in other robotic rotative parking facilities entrances/exits 1202/1, 1202/2, 1202/3, 1204/4 and forward, while adding/extending the quantity of smart cabins in facility 100 and more. Above conveyor/mechanical arms 1203 installed 360° rotatable table 104A with unlimited positions, above rotatable table installed extract and retrieve lifting, shifting arms 104B unit, adjusted for extract and retrieve vehicles from smart cabin 112 and shifting to other positions, the system consist one or more robotic facilities entrance, (i.e. illustrated in different positions).

FIG. 14 shows comperes energy flows with respect to different facilities and services which may be employed by the mechanism of “electric fuel” and Electric Power Station Facility as suggested by the present invention. In fact, implementations will exist in various areas (e.g. see FIG. 12), few may be implemented in interurban areas or anywhere needed as mechanism of “electric fuel” and electric power station service.

The following describes the acronyms of the possible services and software and application management systems that can be provided using the mechanism of “electric fuel” and Electric Power Station Facility and which appear in these milestones figures:

MUHRRECPEEMC—Mechanism of Upright Horizontal Robotic Rotative two floors Elliptic Carousel Parking Electric charge/discharge/accumulate/exchange smart Energy Management Center (software and interface mobile phone applications);

H,M,LVDC—High, Medium, Low Voltage Direct Current, electric cable lines (alternatively AC)

BAREMS—Building, Apartments, Renewable Energy H,M,LVDC, (alternatively AC) Meter smart Management System (software and interface mobile phone applications);

RCDEPSMS—Robotic vertical, horizontal continually, Charge, Discharge Electric, multi (EV,EM,EB) Parking/cabins, boxes, Storages H,M,LVDC, Electric powered wheelchair Management System (software and interface mobile phone applications);

AEBMS—smart Apartment Electric Box, various voltages multiple electric cables lines HVDC ˜100-200V, MVDC ˜12-48V, LVDC ˜5-12V, Meter Management System (software and interface mobile phone applications);

MRMS—Multiple, Renewable HVDC, meter, other systems Management System (software and interface mobile phone applications);

CHWMS—Cooling & Hot Water Meter, Management System (software and interface mobile phone applications)

BOSREMS—Building, Offices, Shops, Commercial, Renewable Energy H, M, LVDC

Management System (software and interface mobile phone applications);

SCSCDMS—Smart Cabin, Smart ports (multiple electric poles/cables), Charge, Discharge H, M, LVDC, Meter, Management System (software and interface mobile phone applications);

CDCSEI—Charge, Discharge; Cable H,M,LVDC Smart ports, Automatic Electromagnetic Induction H,M,LVDC smart ports Management System (software and interface mobile phone applications);

OSEBMS—Office, Shops, rooms Electric junction Box, Medium Voltage DC ˜100-200V, Low voltage DC ˜48V, Meter Management System (software and interface mobile phone applications);

CEVMB—Cluster of EVs, EMs, EBs;

BPBMRECPE—Billing, Payment, Balancing Mechanism of “electric fuel” and station Power station management system (software and interface mobile phone applications);

MEFPERSCV—Mechanism of “electric fuel” and Electric Power stations, Rents/taxis, Security, Camera, Video, Management System (software and interface mobile phone applications);

AWVM—Automatic, hand, Washing Vehicle Machine, Management System (software and interface mobile phone applications);

AENBREV—Accumulator Emergency/peak Night Batteries HVDC, Recycled EVs, EMs, EBs & Meter, Management System (software and interface mobile phone applications)

Although embodiments of the invention have been described by way of illustration, it will be understood that the invention may be carried out with many variations, modifications, and adaptations, without exceeding the scope of the claims.

1. A mechanism of “electric fuel” and electric power station facility, comprising;
smart upright horizontal robotic rotative two-floors elliptic carousel parking electric facility, wherein “side by side” two metal structure columns, supporting upright horizontal rotative two floors elliptic parallel two side link rolling upright arms chain conveyors, shifting between various positions either one or two floors, motorized by an electric motor gearbox, connected through central two-sided axis, transferring power to two sides link rolling upright arms chain conveyors gear systems, alternatively two sides synchronized electric motor, carrying smart parking cabins (at least 6-16 or more) vehicles, connected through cabin's upper main axis shifting cabins adjacent and located in distance from each other correspondingly to supports arms, maintaining arms lengths ratio, relatively to motorized sprocket wheels diameter, depending on plurality of cabin sizes system; and
smart cabins stabilizers consist of metal beams stabilizers connected directly to each main cabin axis, wherein stabilizers moves correspondingly horizontally and vertically in guided track rail and on the arc edge entrances or exits, changing direction through split forked guide track rail, for stabilizing cabins when they shift from one station to another horizontally and vertically, preserving cabins stability in horizontal position all the way upright, carried out at both sides of stabilizer track rail arches, allowing movement at the entrances and/or exits of smart upright horizontal robotic rotative two-floors elliptic carousel parking facility, the same functions are performed, when smart cabin reverses direction at any position and both ends of conveyors in the elliptic arcs position; and
smart cabins comprise; structure frame vehicles platform support structure frame, installed in variety of different tilted angles, relative to cabins main structure frame and relatively positioned between 0°-90° degrees parallel or serial (e.g. 30° 45° 60° degrees) to each other, configured for continuously bi-directional, adjacent and synchronized with horizontal two layers movements, simultaneously on the first level comprising direct entrances and exits in at least 2-sides 0°-90° degrees for each smart cabin; and
each smart cabin comprising smart port designated for mechanism of “electric fuel” electric vehicles batteries charging and/or electric vehicles batteries discharging, considered as electric power supply.

2. The mechanism of “electric fuel” and electric power station facility of claim 1, wherein plurality of smart cabins comprise; e.g. four edges of structure frame supporting vehicles and platform support structure frame are cut off (storage boxes included), allowing installation in places where the width of small parking facility is required, enabling accommodation of one or more electric vehicles.

3. The mechanism of “electric fuel” and electric power station facility claim 1, wherein cabins may serve for various uses like goods storage, delivery goods service drop-off mail boxes around and above vehicles supported by electric charging/discharging/exchange smart ports.

4. The mechanism of “electric fuel” and electric power station facility of claim 1, comprising electric charging and/or discharging and/or exchange smart ports, wherein the smart ports connector are eligible for automatic charging or discharging of electric vehicles, alternatively integrated with approaching pull/push arms mechanism of multiple electromagnetic induction field connection or plug connector operating adjacent to EV front wheel accessibility mechanism.

5. The mechanism of “electric fuel” and electric power station facility of claim 1, wherein plurality of helical or spiral electrical cables multiple electrical wires, connected through main smart cabins electric cable to electric vehicles smarts ports, from there to elliptic guide track rail carrier, dividing them into two sectors of smart upright horizontal robotic rotative two-floors elliptic carousel parking electric facility.

6. The mechanism of “electric fuel” and electric power station facility of claim 1, wherein mechanism of multiple-axial and plurality of slipping's connectors, integrated respectively with improved at least doubling coupled metal (e.g., copper, graphite) & brushes slips conductive and which are mounted on both sides up and down of the rotary multiple slips rings connectors, that are adapted to slide respectively to conductors of bidirectional electric busbars with additional (e.g. 90°) at least two sides of busbars conductors, are adapted to slide on at least 3-systems arrays/formation of conductors of upright horizontal two floors elliptic busbars track rails, transferring and distributing electricity continually without cessation, mounted on anti-rotation bracket comprising elements; used for holding the metal & brush conductors through elliptic guide track rail carrier, while connecting bracket to the metal cover housing of rotary electric multiple slip rings' connector; and used for transferring electric energy, work with electrical conduction system, through horizontal or vertical electromagnetic induction fields (without direct contact), thereby enabling to increase the efficiency and amount of electric power and continue operation, when electric energy is transferred to each single EV battery, in the upright robotic parking mechanism of “electric fuel” and electric power station facility there are simultaneously (at least 6-16 or more) electric vehicles, wherein control management system used for charging/discharge/accumulate/exchange sufficient amount of electric power, simultaneously without cessation even when the electric vehicles smart cabins are rotating or in stop position.

7. The mechanism of “electric fuel” and electric power station facility of claim 1, wherein smart upright horizontal robotic rotative two-floors elliptic carousel parking electric facility, integrated with stable surface and/or grass covering, allowing vehicles to drive on surface from various slope angles to horizontal entrance of robotic parking facility, as well as when smart cabin switching to return direction at any position and at the ends of conveyors in the elliptic arcs positions.

8. The mechanism “electric fuel” and electric power station facility of claim 1, wherein electric vehicle retractable mechanical horizontal arm installed above electric 360° rotatable table, mounting together on conveyor, transporting and rotating vehicles between all horizontal and vertical parking facilities, comprising electric 360° rotatable table with retractable mechanical horizontal arms, designed to turn the vehicle into reverse position facing exit direction, moreover transfer between the various facilities nearby, according to parking/storing needs and electric energy charging and/or discharging and/or accumulate and/or exchange.

9. The mechanism of “electric fuel” and electric power station facility of claim 1, wherein receiving electricity from plurality of energy sources, such as various photovoltaic solar panels or other renewable energy and batteries of electric vehicles, wherein energy sources are combined together and concentrated into high direct current (DC) voltage through one or more mechanism of “electric fuel” and electric power station facilities, wherein each mechanism of “electric fuel” and electric power station facility is adapted to supply plurality of high, medium, low DC voltage in continues manner and without cession, even during the rotation operation of each parking facility or at night, thereby enabling to use each parking facility for charging/discharging plurality of DC or AC consumers/accumulators, simultaneously, previous charged consumers/accumulators with DC energy, may be used as an energy source for charging other DC or AC consumers/accumulators, implementations of mechanism of “electric fuel” and electric power station facilities will exist anywhere.

10. The mechanism of “electric fuel” and electric power station facility of claim 1, wherein upright horizontal robotic rotative two floors elliptic carousel parking facilities are installed in various combinations partially or fully under-ground from zero level surfaces adjacent to building, moreover on top of building roof.

11. The mechanism of “electric fuel” and electric power station facility of claim 1, wherein plurality of horizontal and/or vertical robotic rotative carousel parking facilities, enable to evacuate pathways from parked vehicles and create additional roadside parking space area and provide alternative parking spaces.

12. The mechanism of “electric fuel” and electric power station facility of claim 1, wherein the parking facilities may include robotic & rotary layers-based parking facilities, and nearby mechanism of “electric fuel” and electric power station facility or above, installing various combination of photovoltaic solar panels above streets, junctions and supply alternative renewable energy.

13. The mechanism of “electric fuel” and electric power station facility of claim 1, wherein combination of pattern of smart upright horizontal robotic rotative two-floors elliptic carousel parking electric facilities enable the use of one or more street entrance in between narrow dense buildings, transferring vehicles to other nearby robotic parking facilities located on the buildings' rear sides or street's side, by using retrieval and rotative mechanism, assignment to transporting and rotating vehicles between parking facilities, installed and adjacent or next to each other.

14. The mechanism of “electric fuel” and electric power station facility of claim 1, wherein natural or synthetic grass surface above the horizontal robotic parking facility, would be covered by a synthetic/artificial grass and flora with natural look respectively with playground floor or garden apartments in buildings, when smart upright horizontal robotic rotative two-floors elliptic carousel parking electric facility, is partly below ground zero level surface.

15. The mechanism of “electric fuel” and electric power station facility of claim 1, wherein smart cabins will include electric motorcycle, electric bicycle smart ports for charging and/or discharging and/or accumulate and/or exchange electricity, used also as support and barrier, on the opposite side of installed guide rail used as “security spacers” for electric motorcycle, electric bicycle from other elements.

16. The mechanism of “electric fuel” and electric power station facility of claim 1, wherein smart upright horizontal robotic rotative two-floors elliptic carousel parking electric facility novel integration of smart cabins and automatic vehicles washing machine

17. The mechanism of “electric fuel” and electric power station facility of claim 1, wherein vehicles identification sensors with electronic screens detectors, are used for safety proposes at all entrances and exits to the smart upright horizontal robotic rotative two-floors elliptic carousel parking electric facility.

18. The mechanism of “electric fuel” and electric power station facility of claim 1, wherein the mechanism of “electric fuel” electric power station facility is controlled and managed by software configured to;
determine mobile phone interface with management applications,
assigned to order “pull off vehicles” to the opening of upright horizontal robotic two floors elliptic carousel parking facility comprises central management controlling assignments to integrated with smart apartment electric box, comprising various voltages multiple electric cables lines high volt DC, medium volt DC, low volt DC, meter management system; and
cause transmit command and billing charging and/or discharging and/or accumulate and/or exchange and/or vehicles parking period, according to daily driving uses and storage goods uses, wherein electric energy exchange, hot water consumption, meters, rent/use vehicles time share, video camera, security, billing, payment and balancing obtainment and provision.
